(19) United States
(12) Patent Application Publication
(10) Pub. No.: US 2006/0200288 A1
(43) Pub. Date: Sep. 7, 2006

(54) Rollover determining apparatus

(75) Inventor: Naotoshi Takemura, Wako-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/364,166

(22) Filed: Feb. 28, 2006

(30) Foreign Application Priority Data
Mar. 1, 2005 (JP) 2005-055759

(51) Int. Cl. B60G 17/018

(52) U.S. Cl. 701/38; 701/37

(57) ABSTRACT

In a rollover determining apparatus including a roll rate sensor and a rollover determining unit for determining a rollover of the vehicle on the basis of the roll rate signal to generate a rollover determination signal, which are integrally housed within the vehicle, the rollover determining unit is inhibited from outputting the rollover determination signal when both the collision determination signal and the traveling status determination signal are absent and permitting the rollover determining unit to generate the rollover determination signal when at least one of the collision detection signal indicating a collision of the vehicle and the traveling status detection signal indicating a traveling status of the vehicle is present. The collision may be detected with a front collision sensor and/or a side collision sensor. The traveling status is detected with a vehicle velocity sensor and/or a skid sensor.

### BACKGROUND OF THE INVENTION

1. Field of the Invention

The present invention relates to a rollover determining apparatus for determining a rollover of a vehicle through detection of a rollover movement of the vehicle to allow a passenger protection unit to operate when the presence of a possibility in occurrence of the rollover of the vehicle is detected.

2. Description of the Related Art

Rollover determining apparatuses for determining a rollover of a vehicle are known. Japanese laid-open patent application publication No. 2003-34226 discloses such a rollover determining apparatus at paragraph [0025] and in FIG. 2. This rollover determining apparatus includes, to operate a passenger protection unit, a first roll rate sensor for detecting a roll rate of a vehicle, a lateral direction acceleration detector for detecting an acceleration in a lateral direction of the vehicle, and a rollover determining unit for judging whether or not there is a possibility that a rollover occurs in the vehicle on the basis of the roll rate and the acceleration in the lateral direction of the vehicle to determine the possibility. This rollover determining apparatus further includes a second roll rate sensor as a safe mechanism for confirming the determined rollover of the vehicle at the rollover determining unit.

### SUMMARY OF THE INVENTION

A first aspect of the present invention provides a rollover determining apparatus comprising: a roll rate detection unit for detecting a roll rate of itself to generate a roll rate signal to detect a roll rate of a vehicle; and a rollover determining unit for judging a rollover of the roll rate detection unit to determine a rollover of the vehicle on the basis of the roll rate signal to generate a rollover determination signal, the roll rate detection unit and the rollover determining unit being integrally housed within the vehicle; a collision determining unit supplied with a collision detection signal for determining a collision of the vehicle to generate a collision determination signal; a traveling status determining unit supplied with a traveling status detection signal for determining a traveling status of the vehicle to generate a traveling status determination signal; and an inhibition-permission unit for inhibiting outputting the rollover determination signal when both the collision determination signal and the traveling status determination signal are not supplied thereto and permitting outputting the rollover determination signal when at least one of the collision determination signal and the traveling status determination signal is supplied thereto.

According to this configuration, even though the roll rate detection unit detects the roll rate signal indicating the rollover, the rollover determination based on the roll rate signal is inhibited when both the collision status and the traveling status are not determined. On the other hand, the rollover determining apparatus may determine the rollover on the basis of the roll rate signal when at least one of the collision status and the traveling status are determined. Thus, this configuration may prevent an erroneous deployment of the passenger protection apparatus during maintenance with a sure operation of the passenger protection unit.

Preferably, the collision may be detected by a front collision sensor for detecting a front collision of the vehicle and/or a side collision may be detected by a side collision sensor. According to this configuration, the rollover determining apparatus may determine a possibility of the rollover due to a front collision or a side collision based on the roll rate signal while at least one of the front collision or the side collision is detected to surely operate the passenger protection.

Preferably, a traveling status is detected by a vehicle velocity sensor for detecting a vehicle velocity and/or a skid sensor for detecting a skid of the vehicle. According to this configuration, because there is the possibility of the rollover of the vehicle when the traveling vehicle runs on something, the rollover determining apparatus may determine the rollover movement from the roll rate signal during detection of a certain vehicle velocity and the skid, so that the passengers are surely protected from the rollover by deploying the passenger protection unit as needed.

When both the traveling status and the collision are not determined, this corresponds to a status that the vehicle normally stops (without collision). In this status if the rollover determining apparatus is removed, this operation is carried out when the vehicle normally stops (without collision). Thus, both the traveling status and the collision are not determined, which the status should inhibit the rollover determination. As a result, the rollover determining apparatus does not carry out the final rollover determination though the roll rate signal indicating that the rollover is supplied from the roll rate detection unit while the rollover determination is inhibited.

Accordingly, it is clearly understood that there is no possibility of the rollover of the vehicle in a case that the vehicle normally stops (without collision). Thus, though the roll rate signal indicating the rollover is supplied, it can be judged to be not actually derived from the rollover of the vehicle. Consequently, when neither of the traveling status nor the collision is determined, it can be determined that the vehicle normally stops (without a collision), so that the determination of the rollover based only on the roll rate signal is prevented.

A second aspect of the present invention provides a rollover determining apparatus comprising: a roll rate detection unit for detecting a roll rate of itself to detect a roll rate of a vehicle to generate a roll rate signal; a rollover determining unit for judging a rollover of the roll rate detection unit to generate a rollover determination signal to determine a rollover of the vehicle on the basis of the roll rate signal, the roll rate detection unit and the rollover determining unit being integrally housed within the vehicle; a traveling status detection unit for detecting a status of the vehicle to generate a traveling status detection signal unrelated to the roll rate signal; a traveling status determining unit for determining a vehicle status except the rollover of the vehicle to generate a traveling status determination signal indicating either of traveling or stop of the vehicle; and an inhibition-permission unit for inhibiting outputting the rollover determination signal in response to the traveling status determination signal when the traveling status detection signal indicates the stop.

### BRIEF DESCRIPTION OF THE DRAWINGS

The object and features of the present invention will become more readily apparent from the following detailed description taken in conjunction with the accompanying drawings in which:

FIG. 1 is a block diagram of the rollover determining apparatus of an embodiment according to the present invention;

FIG. 2 is a schematic plan view of a vehicle to show mounting locations of units relating to the rollover determining apparatus and connection relations;

FIGS. 3 and 4 are flow charts for describing operations of the rollover determining apparatus.

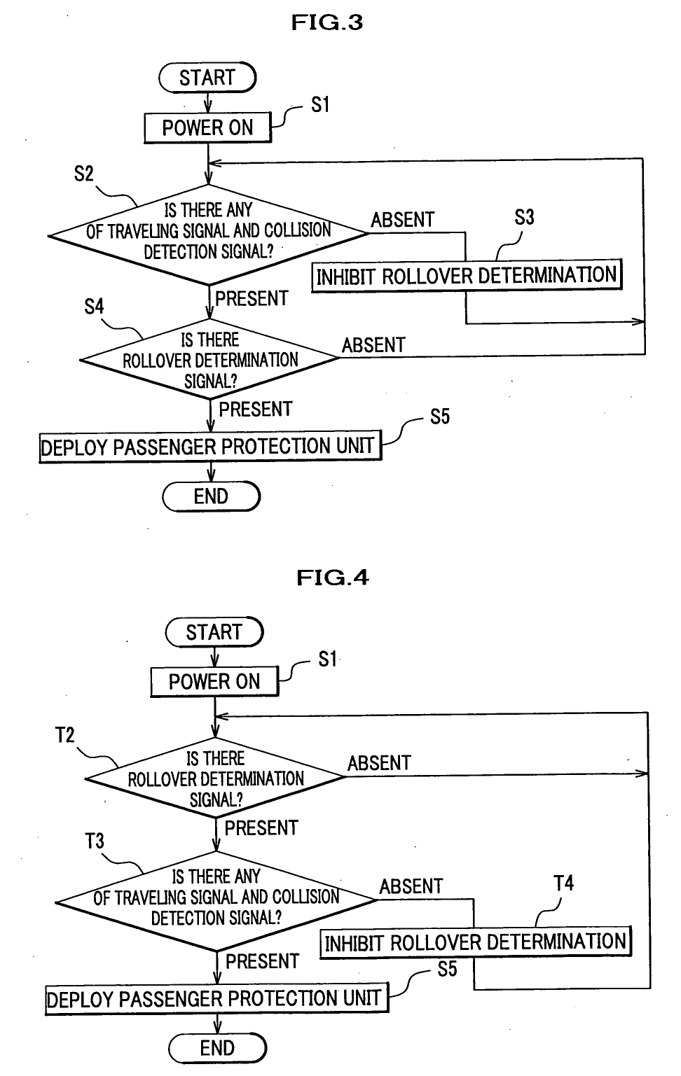

The same or corresponding elements or parts are designated with like references throughout the drawings.

### DETAILED DESCRIPTION OF THE INVENTION

Prior to describing an embodiment of the present invention, the rollover determining apparatus disclosed in Japanese laid-open patent application publication No. 2003-34226 will be further argued.

In such a rollover determining apparatus, it may be configured to be integrally disposed in a floor tunnel at a middle of the vehicle to protect passengers by operating the passenger protection unit when the rollover of the vehicle is detected. In other words, the rollover determining apparatus may be mounted in and dismounted from the floor tunnel integrally. In addition, in the floor tunnel, power connectors for supplying a power to respective units and a signal line connected to a passenger protection unit are mounted.

In this case, if the rollover determining apparatus is removed from the floor tunnel for maintenance or a repairing during turn-on of the ignition switch, the rollover determining apparatus erroneously determines that the vehicle is rolled over if the operator forgets to turn off the ignition switch or disconnect the power connectors or the signal line, so that the passenger protection unit will be actuated.

The present invention provides a rollover determining apparatus capable of avoiding the erroneous vehicle rollover determination even if the operator forgets one of turning off of the ignition switch, a disconnection of power connector, and a disconnection of the signal line to the passenger protection unit.

To prevent the erroneous determination of the rollover of the vehicle in the rollover determining apparatus in which the roll rate detection unit and the rollover determining units are integrally mounted in a certain place of the vehicle, the rollover determination is inhibited when neither the collision nor the traveling status is determined. On the other hand, in the presence of at least one of a collision status determination and a traveling status determination, the rollover determination is permitted.

Hereinafter, will be described an embodiment of the present invention with reference to drawings.

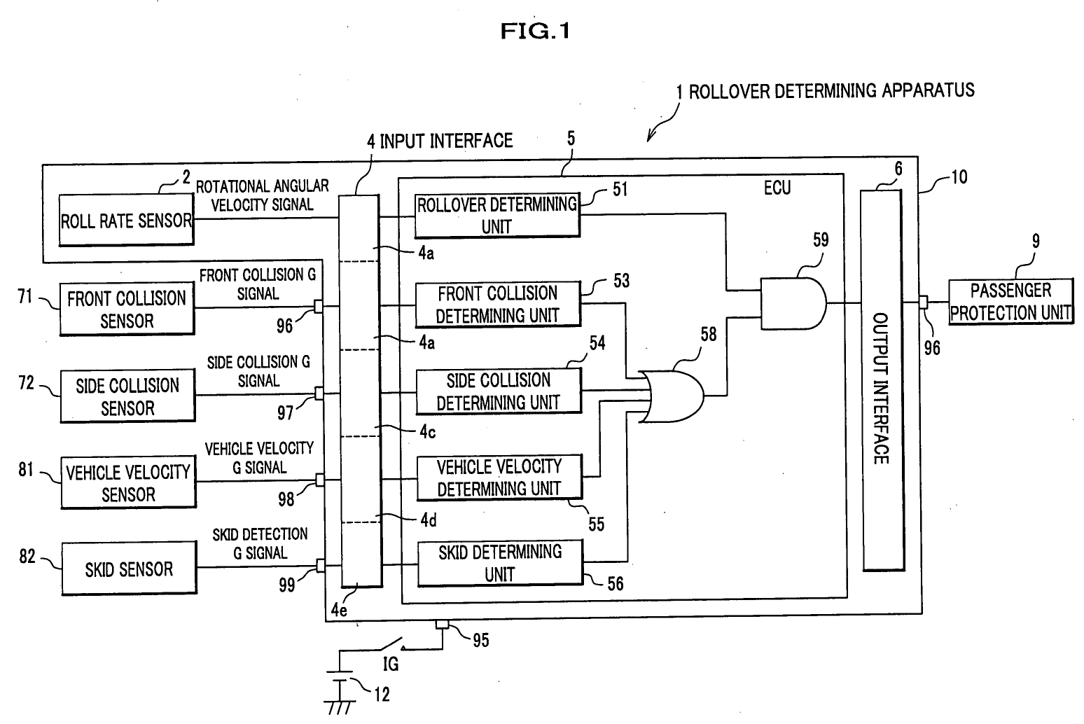

First, will be described a configuration of the rollover determining apparatus with reference to a block diagram shown in FIG. 1. The rollover determining apparatus 1 includes a roll rate sensor 2, an input interface 4, an ECU (Electronic Control Unit) 5, an output interface 6, which are integrally housed in a case 10 disposed in a floor tunnel 11 of a vehicle. Further, the rollover determining apparatus 1 is connected to a power supply 12 through an ignition switch IG and a power connector 95.

The roll rate sensor 2 detects a rotational angular velocity showing a possibility of a rollover of the vehicle to generate the roll rate signal. More specifically, the role rate sensor 2 is a sensor for detecting a rotational angular velocity based on Carioles force such as an acceleration sensor and a gas gyro that detect a force occurring at a predetermined mass in accordance with rotation around a front and a rear axle of the vehicle to generate a roll rate signal.

Connected to the rollover determining apparatus 1 are a front collision sensor 71 as a collision detector, a side collision sensor 72 as a side collision detector, a vehicle velocity sensor 81 as a traveling status detector, and a skid sensor 82 as another traveling status detector. They are mounted on the vehicle independently of the rollover determining apparatus 1, but connected to the rollover determining apparatus 1 with signal lines. Thus they are generally referred to as external sensors. On the other hand, the roll rate sensor 2 can be referred to as an internal sensor.

The front collision sensor 71 is an acceleration sensor for detecting a collision on a front side of the vehicle. Here, an acceleration detected by the front collision sensor 71 is referred to as “front collision G (gravity)” and its signal is referred to as “a front collision G signal”. The side collision sensor 72 is an accelerometer for detecting a collision on a side of the vehicle. Thus, an acceleration detected by the side collision sensor 72 is also referred to as “side collision G” and its detection signal is referred to as “side collision G signal.” The vehicle velocity sensor 81 detects a vehicle velocity, and thus a signal indicating the velocity of the vehicle detected by the vehicle velocity sensor 81 is referred to as “vehicle velocity signal.” The skid sensor 82 is a sensor for detecting a skid of the vehicle. Thus, a signal indicating the skid detected by the skid sensor 82 is referred to as “skid detection signal.”

The input interface 4 is supplied with the rotational angular velocity (roll rate signal) from the roll rate sensor 2, the front collision G signal from the front collision sensor 71, the side collision G signal from the side collision sensor 72, the vehicle velocity signal from the vehicle velocity sensor 81, and the skid detection signal from the skid sensor 82 and supplies them to the ECU 5.

The ECU 5 determines a rollover of the vehicle based on the roll rate signal detected by the roll rate sensor 2 and presence or absence in inhibition of the rollover determination on the bases of the front collision G signal, the side collision G signal, the vehicle velocity signal, and the skid detection signal detected by the front collision sensor 71, the side collision sensor 72, the vehicle velocity sensor 81, and the skid sensor 82, respectively. Further the ECU 5 performs a function for controlling an engine and other units.

More specifically, the ECU 5 includes a rollover determining unit 51, a front collision determining unit 53, a side collision determining unit 54, a vehicle velocity determining unit 55, a skid determining unit 56, an inhibition determination OR gate 58 for determining permission and inhibition, and an AND gate 59.

The rollover determining unit 51 judges whether or not the roll rate signal supplied through the input interface 4 is equal to or greater than a first predetermined value to determine the rollover of the vehicle and supplies a rollover determination signal to the AND gate 59 when the roll rate signal is equal to or greater than the first predetermined value.

The front collision determining unit 53 judges whether or not the front collision G signal supplied through the input interface 4 is equal to or greater than a second predetermined value to determine a front collision and supplies a front collision determination signal to the inhibition determination OR gate 58 when the front collision G signal is equal to or greater than the second predetermined value. The side collision determining unit 54 judges whether or not the side collision G signal supplied through the input interface 4 is equal to or greater than a third predetermined value to determine a side collision and supplies a side collision determination signal to the inhibition determination OR gate 58 when the side collision G signal is equal to or greater than the third predetermined value. The vehicle velocity determining unit 55 judges whether or not the vehicle velocity signal supplied through the input interface 4 is equal to or greater than a fourth predetermined value to determine a traveling status and supplies a velocity determination signal as a first traveling signal to the inhibition determination OR gate 58 when the vehicle velocity signal is equal to or greater than the fourth predetermined value. The skid determining unit 56 judges whether or not the skid detection signal supplied through the input interface 4 is equal to or greater than a fifth predetermined value to determine a skid and supplies a skid determination signal as a second traveling signal to the inhibition determination OR gate 58 when the skid detection signal is equal to or greater than the fifth predetermined value.

The case that the roll rate signal from the roll rate sensor 2 is equal to or greater than the first predetermined value means that the vehicle may become in a status of the rollover in which the vehicle inclines more than about 90 degrees. Here, it is said that the vehicle does not roll over even if a rollover movement occurs around any of the front and rear axels, as long as an inclination does not exceed a predetermined angle (maximum stable inclining angle). Thus, a possibility of the rollover of the vehicle can be determined in accordance with whether rotational energy of the vehicle derived from the rotational angular velocity (roll rate signal) exceeds energy necessary for the inclination angle to reach the maximum stable inclining angle. The predetermined value of the rotational angular velocity is a value necessary for obtaining the rotational energy.

Further, the second and third predetermined values for the front collision G signal and the side collision G signal correspond to values indicating rapid acceleration variations representing collisions. The fourth predetermined value corresponds to the vehicle velocity signal indicates 0 km/h representing a stop of the vehicle. The fifth predetermined value for the skid detection signal also corresponds to a status in which there is no skid. In other words, these values indicate a status that the vehicle normally (without a collision) stops. Setting the predetermined values as mentioned above allows the rollover determining apparatus 1 to be removed from the vehicle during the maintenance without deployment of the passenger protection unit 9 irrespective of an on/off status of the power for the rollover determining apparatus 1 and disconnection of the signal line for the passenger protection unit 9, when the vehicle is normally stops (without a collision).

The inhibition determination OR gate 58 is a logic circuit for determining the presence or absence of the inhibition of the rollover determination. The inhibition determination OR gate 58 operates so as to supply a H level of a permission/inhibition signal to the AND gate 59 when at least one of levels of the front collision determining circuit 53, the side collision determining circuit 54, the velocity determining circuit 55, and the skid determining circuit is equal to or greater than a threshold voltage of the inhibition determination OR gate 58. On the other hand, when any of the levels is not equal to or greater than the threshold voltage of the inhibition determination OR gate 58, the inhibition determination OR gate 58 supplies a L level of the permission/inhibition signal to the AND gate 59.

The AND gate 59 is a logic circuit for performing a permission/inhibition operation of the rollover determination. The AND gate 59 supplies or does not supply the rollover determination signal from the rollover determining unit 51 as a command signal to the passenger protection unit 9 through the output interface 6 in accordance of the permission/inhibition signal. More specifically, the AND gate 59 supplies the command signal indicating the presence of the rollover if the permission/inhibition signal supplied from the inhibition determination OR gate 58 has the H level, on the other hand, does not supply, upon a L level of the permission/inhibition signal, the command signal to the output interface 6 although the output from the rollover determining unit 51 has the voltage equal to or greater than the threshold voltage. This allows the AND gate 59 to inhibit the rollover determination when the permission/inhibition signal has the L level, namely, when the signals from the front sensor 71, the side collision sensor 72, and the vehicle velocity sensor 81, and the skid detection sensor 82 are lower than the threshold voltage of the inhibition determination OR gate 58, respectively.

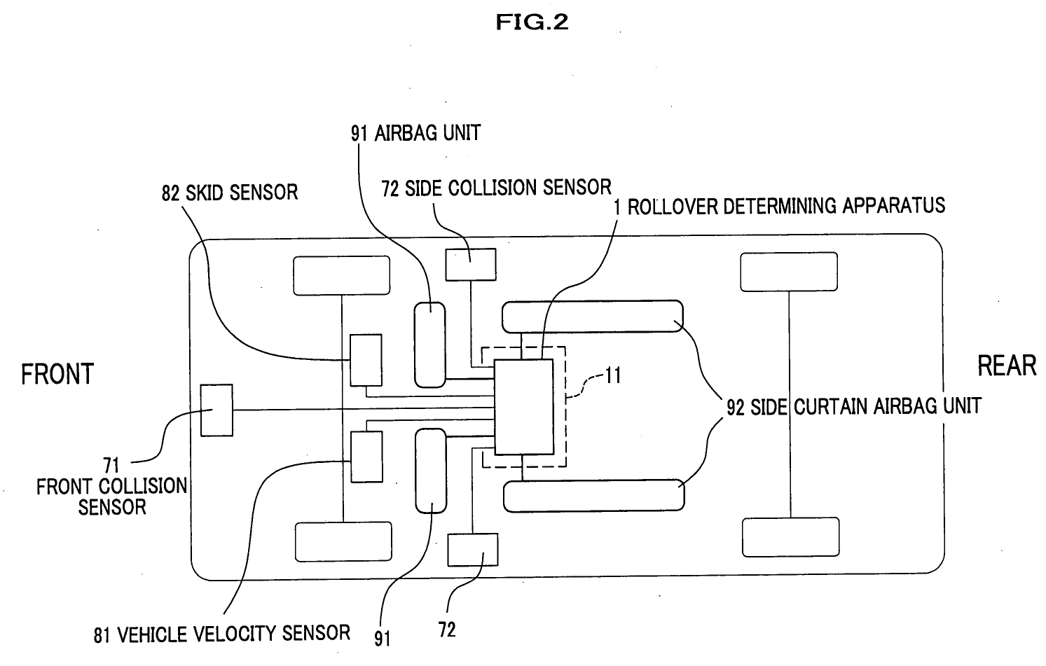

The output interface 6 is provided to supply the command signal from the AND gate 59 to the passenger protection unit 9. The passenger protection unit 9 includes an airbag unit 91 for deployment of the airbag in response to the command signal from the rollover determination apparatus 1 (see FIG. 2), a side curtain airbag unit 92 mentioned later (see FIG. 2), and the like. When being supplied with the command signal from the rollover determination apparatus 1, the passenger protection unit 9 performs the deployment of the airbag by allowing a current to flow through an ignition circuit for a gas generator (not shown).

Thus, in the rollover determining apparatus 1, when the power from the power supply 12 is turned on, the roll rate sensor 2 generates the roll rate signal and thus, the rollover determining unit 51 determines the rollover from the roll rate signal (the rotational angular velocity). When being supplied with the roll rate signal having a value equal to or greater than the first predetermined value, the rollover determining unit 51 supplies the rollover determination signal to the AND gate 59 because there is the possibility of the rollover. However, if being supplied with only the rollover determination signal from the rollover determining unit 51, the AND gate 59 does not supply the command signal for deployment of the airbag to the passenger protection unit 9. In other words, when the permission/inhibition signal has the L level, the AND gate 59 does not supply the command signal to the passenger protection unit 9.

On the other hand, when at least one of the front collision determining unit 53, the side collision determining unit 54, the vehicle velocity determining unit 55, and the skid determining unit 56 provides determination, the determination result is supplied to the inhibition determining OR gate 58. Accordingly, when being supplied with the rollover determination signal from the rollover determining unit 51, the AND gate 59, also supplied with the permission/inhibition signal of the H level from the inhibition OR gate 58, supplies the command signal to the passenger protection unit 9 because there is the possibility of the rollover.

Next will be described reasons why the inhibition of the rollover determination can be provided with first and second traveling signals (vehicle velocity signal and the skid detection signal) and the collision detection signals.

The rollover will occur when some factors conspire in any of the following three cases.

(1) When traveling, the vehicle rolls over by receiving a lateral force in a collision.

In this case, the vehicle velocity determining unit 55 and the skid determining unit 56 output the first and second traveling signals as well as the rollover determining unit 51 outputs the rollover determination signal while the front collision determining unit 53 and the side collision determining unit 54 output the front collision determination signal and the side collision determination signal. In this event, while receiving the first and second traveling signals and the front and side collision determination signals, the ECU 5 receives the roll rate signal indicating the rollover. Accordingly, when receiving the first and second traveling signals and the front and side collision determination signals, the ECU 5 provides the rollover determination using the roll rate signal without the inhibition of the rollover determination.

(2) When receiving a force in the lateral direction by a collision during a stop, the vehicle rolls over.

In this case, the roll rate sensor 2 outputs the roll rate signal indicating the rollover of the vehicle while the vehicle velocity determining unit 55 and the skid determining unit 56 do not output the first and second traveling signals, respectively, but the front collision determining unit 53 and the side collision determining unit 54 output the front and side collision detection signals. In this event, while determining the front and side collisions, the ECU 5 receives the roll rate signal indicating the rollover. Thus, when determining the front and side collisions, the ECU 5 provides the rollover determination with the roll rate signal without inhibition of the rollover determination.

(3) While traveling without a collision, the vehicle, running onto something, rolls over.

In this case, the roll rate sensor 2 outputs the roll rate signal indicating the rollover while the vehicle velocity determining unit 55 and the skid determining unit 56 output the first and second traveling signals, respectively. On the other hand, the front collision determining unit 53 and the side collision determining unit 54 do not output the front and side collision determination signals. In this event, while the first and second traveling signals are generated, the ECU 5 receives the roll rate signal indicating the rollover. Accordingly, while the first and second traveling signals are generated, the ECU 5 provides the rollover determination with the roll rate signal indicating the rollover without the inhibition of the rollover determination.

Thus, when the vehicle does not roll over, this case does not correspond to any of cases (1) to (3). In other words, a normally stop of the vehicle (without a collision) means that there is no rollover. This is case that there is no collision determination and no traveling signals, namely, the determination inhibition OR gate 58 receives no determination signal. Accordingly, when there is neither the collision determination nor the first and second traveling signals, the vehicle normally stops without the possibility of the rollover. This condition inhibits the rollover determination.

Further, if there is at least one of the collision determination and generation of the first and second traveling signals, this case corresponds to one of the cases (1) to (3), which provides the determination that there is the possibility of the rollover of the vehicle.

Next will be described a manner of mounting the rollover determining apparatus 1, the external sensors, and the passenger protection unit 9 on the vehicle. The rollover determining apparatus 1 is mounted in the floor tunnel 11 located at an approximately middle of the vehicle.

As shown in FIG. 1, mounted on a front side of the vehicle in a traveling direction (the middle on a left side in FIG. 2) is the front collision sensor 71. Mounted on right and left sides regarding the traveling direction are the side collision sensors 72. Mounted around the axel are the vehicle velocity sensor 81 and the skid detection sensor 82. Further, mounted around the front seats of the vehicle (a driver seat and a passenger seat) are the airbag units 91 included in the passenger protection unit 9.

In addition, mounted around left and right side windows are side curtain airbag units 92 included in the passenger protection unit 9 for covering the side windows upon the deployment. The front collision sensor 71, the side collision sensor 72, the vehicle velocity sensor 81, the skid detection sensor 82, the airbag units 91, and the side curtain airbag units 92 are connected to the rollover determining apparatus 1 through signal lines.

Next, will be described a rollover determination process of the rollover determining apparatus 1 having the configuration mentioned above. Here, in the following description, it is assumed that the ECU 5 executes the process.

First, when the power is turned on (S1), the ECU 5 judges whether there are the first and second traveling signals and the front and side collision determination signals (S2). If determining that none of the first and second traveling signals and the front and side collision determination signals exists (“absent” in S2), the ECU 5 inhibits the determination of the rollover (S3), and repeats the process in the step S2. When determining that at least one of the first and second traveling signals and the front and side collision determination signals exists (“present” in S2), the ECU 5 judges whether there is the roll rate signal having a value equal to or greater than the first predetermined value (S4). When the roll rate signal has the value equal to or greater than the first predetermined value (“present” in S4), the ECU 5 deploys the passenger protection unit 9 (S5). When the roll rate signal has the value smaller than the first predetermined value (“absent” in S4), the ECU 5 repeats the process from S2 to S4.

Here, the process is described such that it is conducted in such an order of judgment (S2) of whether the first and second traveling signals and the front and side collision determination signals are present or absent and the judgment (S4) of whether the roll rate signal is present or absent.

However, this order can be inversed. In other words, as shown in FIG. 4, the ECU 5 executes the judgment whether the roll rate signal having the value equal to or greater than the predetermined value is present or absent (T2 corresponding to S4) after tuning on of the power, and when the roll rate signal is equal to or greater than the first predetermined value (“present” in T2), executes a judgment whether the first and second traveling signals and the front and side collision determination signals are present or absent (T3 corresponding to S2).

When the roll rate determination signal is not generated (“absent in T2), the ECU 5 repeats the process in T2. The ECU 5 determines that none of the first and second traveling signals and the front and side collision determination signals exists (“absent in T3”), the ECU 5 inhibits the determination of the rollover (T4 corresponding to S3). In addition, if at least one of the first and second traveling signals and the front and side collision determination signals are supplied (“present” in T3), the ECU 5 deploys the passenger protection unit 9 (S5).

The process may be performed as just mentioned above.

In addition, the function of the ECU 5 also can be provided by executing such a program with a general computer to operate operation units and storage units within the computer. Such the rollover determining program can be distributed through a communication line and through various recording media for storing such the program.

The embodiment has been described with the case that the rollover determination is performed with the rotational angular velocity (roll rate signal). However, a lateral direction acceleration sensor for detecting acceleration in the lateral direction of the vehicle and an upper direction acceleration sensor for detecting acceleration in the upward and downward directions of the vehicle may be integrally disposed within the floor tunnel 11 in addition to the roll rate sensor 2.

As above, the rollover determination made with the lateral direction acceleration and/or the upward/downward acceleration in addition to the roll rate signal provides the determination at a further high accuracy. In addition, the configuration with these various sensors can prevent the rollover determining unit from erroneously determining the rollover, even if the operator forgets to turn off the ignition IG or the disconnection of the signal lines.

Thus, according to the present invention, it is determined that the vehicle normally stops and thus is in a non-rollover status, in accordance with the presence or absence of the front and side collision determination signals and the first and second traveling signals. This prevents the rollover determining apparatus from erroneously determining the rollover when the rollover determining unit is removed from the floor tunnel 11, even though the operator forgets to turn off the ignition IG or disconnect a connector 96 for the command signal.

As mentioned above the rollover determining apparatus 1 includes: a roll rate sensor 2 for detecting the roll rate of itself to detect the roll rate of the vehicle to generate the roll rate signal; the rollover determining unit 51 for judging the rollover of the roll rate sensor 2 to generate the rollover determination signal to determine the rollover of the vehicle on the basis of the roll rate signal, the roll rate sensor 2 and the rollover determining unit 51 being integrally housed within the vehicle; a traveling status detection unit including the front collision sensor 71, the vehicle velocity sensor 72, and the skid sensor 82, for detecting the status of the vehicle to generate a traveling status detection signal (front collision G signal, vehicle velocity G signal, the skid detection G signal) unrelated to the roll rate signal; a traveling status determining unit including the front collision determining unit 53, the vehicle velocity determining unit 55, and the skid determining unit 56 for determining the vehicle status except the rollover of the vehicle to generate a traveling status determination signal indicating either of traveling or stop of the vehicle; and the OR gate 58 and the AND gate 59 as an inhibition-permission unit for inhibiting outputting the rollover determination signal in response to the traveling status determination signal when the traveling status detection signal indicates the stop.

The rollover determining apparatus may further include: the case 10 mountable on the floor tunnel 11 of the vehicle for housing the roll rate sensor 2, the rollover determining unit 51, the front collision determining unit 53, the traveling status determining unit, and the inhibition-permission unit, which are supplied with the power through the connector 95; the front collision sensor 71 (side collision sensor 72) as the collision sensor disposed in the vehicle and externally of the case 10 for generating the collision detection signal; and the vehicle velocity sensor 81 (the skid sensor 82) as a traveling status sensor disposed in the vehicle and externally of the case 10 for generating the traveling status detection signal. The rollover determination signal is supplied to the passenger protection unit 9 of the vehicle, the inhibition-permission unit inhibits supplying the rollover determination signal as the command signal to the passenger protection unit 9 in response to the traveling status detection signal when the case 10 is rolled over after removal of the case 10 from the vehicle without disconnection of the connector 96 during a stop of the vehicle.

In the above described embodiment, the roll rate sensor 2, the front collision sensor 71, the side collision sensor 72, the vehicle velocity sensor 81, and the skid sensor 82 generate analog output signals, and thus the input interface 4 may includes a/d converters (not shown) to supply digital detection signals to the rollover determining unit 51, the front collision determining unit 53, the side collision determining unit 54, the vehicle speed determining unit 55, and the skid determining unit 56, respectively.

On the other hand, if the roll rate sensor 2, the front collision sensor 71, the side collision sensor 72, the vehicle velocity sensor 81, and the skid sensor 82 generate digital output signals, the input interface 4 requires no a/d converter.

Further, the rollover determining unit 51, the front collision determining unit 53, the side collision determining unit 54, the vehicle velocity determining unit 55, and the skid determining unit 56 may be provided in the roll rate sensor 2, the front collision sensor 71, the side collision sensor 72, the vehicle velocity sensor 81, and the skid sensor 82, respectively.

Operations of the rollover determining unit 51, the front collision determining unit 53, the side collision determining unit 54, the vehicle speed determining unit 55, the skid determining unit 56, inhibition determining OR gate 58, and the AND gate 59 are provided with the program in the ECU 5.

However, these operations may be provided with discrete circuits.

In the configuration of the rollover determining apparatus shown in FIG. 1, positive logic circuits are used. However, negative logic circuits can be used. Further, output levels of the roll rate sensor 2, the front collision sensor 71, the side collision sensor 72, the vehicle velocity sensor 81, and the skid sensor 82 increase with detected amounts, respectively. However, this relation can be reversed with suitable criteria with a suitable logic configuration.

In the above mentioned embodiment, the input interface 4 includes input circuits 4a to 4e for receiving the rotational angular velocity signal, the front collision G signal, the side collision G signal, the vehicle velocity G signal and the skid detection G signal, respectively. The front collision G signal, the side collision G signal, the vehicle velocity G signal and the skid detection G signal are supplied through connectors 96 to 99, respectively. Further, the front collision sensor 71, the side collision sensor 72, the vehicle velocity sensor 81, and the skid sensor 82 generate low voltages of the front collision G signal, the side collision g signal, the vehicle velocity G signal, and the skid detection G signal when there no front collision, no side collision, stop of the vehicle, and no skid, respectively.

In this configuration, when the operator disconnects these connectors 96 to 99 and the connector 95 for the maintenance, if the operator first disconnects the connector 95, there is no problem even though the ignition switch IG is ON because the power is cut off by the disconnection of the connector 95. However, if the operator first disconnects one of the connectors 96 to 99, there is a possibility that the corresponding one of the input circuits 4a to 4e senses an input voltage indicating a front collision, a side collision, a vehicle traveling status, or the skid status depending on the circuit configuration of the input circuits 4a to 4e. Further, if it is assumed that the input circuits 4b to 4e sense low voltages when the connectors 96 to 99 are disconnected, respectively. If, for example, the front collision sensor 71 is designed to generate the front collision G signal of a low voltage when there is the front collision, the input circuit 4b senses the low voltage indicating a collision upon disconnection of the connector 96.

Thus, the input circuits 4b to 4e and the front collision sensor 71, the side collision sensor 72, and the vehicle velocity sensor 81, and the skid sensor 82 are configured to generate voltages indicating no front collision, no side collision, a stop of the vehicle, and no skid of the vehicle, respectively when the connectors 96 to 99 are disconnected. Similarly, the second to fifth predetermined values may be set to prevent erroneous detection.

The invention claimed is:

1. A rollover determining apparatus comprising:
a roll rate detection unit for detecting a roll rate of itself to generate a roll rate signal to detect a roll rate of a vehicle; and
a rollover determining unit for judging a rollover of the roll rate detection unit to determine a rollover of the vehicle on the basis of the roll rate signal to generate a rollover determination signal, the roll rate detection unit and the rollover determining unit being integrally housed within the vehicle;
a collision determining unit supplied with a collision detection signal for determining a collision of the vehicle to generate a collision determination signal;
a traveling status determining unit supplied with a traveling status detection signal for determining a traveling status of the vehicle to generate a traveling status determination signal; and
an inhibition-permission unit for inhibiting outputting the rollover determination signal when both the collision determination signal and the traveling status determination signal are not supplied thereto and permitting outputting the rollover determination signal when at least one of the collision determination signal and the traveling status determination signal is supplied thereto.

2. The rollover determining apparatus as claimed in claim 1, further comprising:
a case mountable on the vehicle for housing the roll rate detection unit, the rollover determining unit, the collision determining unit, the traveling status determining unit, and the inhibition-permission unit, which are supplied with a power through a connector;
a collision sensor disposed in the vehicle and externally of the case for generating the collision detection signal; and
a traveling status sensor disposed in the vehicle and externally of the case for generating the traveling status detection signal, wherein the rollover determination signal is supplied to a passenger protection unit of the vehicle, the inhibition-permission unit inhibits supplying the rollover determination signal to the passenger protection unit in response to the collision status determination signal and the traveling status determination signal when the case is rolled over after removal of the case from the vehicle without disconnection of the connector during a stop of the vehicle.

3. The rollover determining apparatus as claimed in claim 2, wherein the collision sensor comprises a front collision sensor for detecting a front collision of the vehicle.

4. The rollover determining apparatus as claimed in claim 2, wherein the traveling status sensor comprises a side collision sensor for detecting a side collision of the vehicle.

5. The rollover determining apparatus as claimed in claim 2, wherein the traveling status detection sensor comprises a vehicle velocity sensor for detecting a velocity of the vehicle.

6. The rollover determining apparatus as claimed in claim 2, wherein the traveling status detection sensor comprises a skid sensor for detecting a skid of the vehicle.

7. A rollover determining apparatus comprising:
a roll rate detection unit for detecting a roll rate of itself to detect a roll rate of a vehicle to generate a roll rate signal;
a rollover determining unit for judging a rollover of the roll rate detection unit to generate a rollover determination signal to determine a rollover of the vehicle on the basis of the roll rate signal, the roll rate detection unit and the rollover determining unit being integrally housed within the vehicle;
a traveling status detection unit for detecting a status of the vehicle to generate a traveling status detection signal unrelated to the roll rate signal;
a traveling status determining unit for determining a vehicle status except the rollover of the vehicle to generate a traveling status determination signal indicating either of traveling or stop of the vehicle; and
an inhibition-permission unit for inhibiting outputting the rollover determination signal in response to the traveling status determination signal when the traveling status detection signal indicates the stop.

8. The rollover determining apparatus as claimed in claim 7, further comprising:
a case mountable on a floor tunnel of the vehicle for housing the roll rate detection unit, the rollover determining unit, the traveling status determining unit, and the inhibition-permission unit, which are supplied with a power;
a collision sensor disposed in the vehicle and externally of the case for generating a collision detection signal; wherein
a traveling status detection unit disposed in the vehicle and externally of the case for generating the traveling status detection signal, the rollover determination signal is supplied to a passenger protection unit of the vehicle, the inhibition-permission unit inhibits supplying the rollover determination signal to the passenger protection unit in response to the traveling status determination signal when the case is rolled over after removal of the case from the vehicle without disconnection of the connector during a stop of the vehicle.

9. The rollover determining apparatus as claimed in claim 8, wherein the collision sensor comprises a front collision sensor for detecting a front collision of the vehicle.

10. The rollover determining apparatus as claimed in claim 7, wherein the traveling status detection unit comprises a vehicle velocity sensor for detecting a velocity of the vehicle.

11. The rollover determining apparatus as claimed in claim 7, wherein the traveling status detection unit comprises a skid sensor for detecting a skid of the vehicle.
